(19) United States
(12) Patent Application Publication
(10) Pub. No.: US 2015/0375428 A1
(43) Pub. Date: Dec. 31, 2015

(54) CLOSED-CELL POLYURETHANE STRUCTURE METHOD AND SYSTEM

(71) Applicant: Douglas E. Reeves, Edmond, OK (US)

(72) Inventor: Douglas E. Reeves, Edmond, OK (US)

(21) Appl. No.: 14/851,914

(22) Filed: Sep. 11, 2015

Related U.S. Application Data
(63) Continuation-in-part of application No. 13/649,861, filed on Oct. 11, 2012.

(51) Int. Cl. B29C 39/10; E04H 12/22; B29C 39/12; C08G 18/76; B29C 31/00; B29C 31/02; C08G 18/32; C08G 18/08; B29C 39/44

(52) U.S. Cl. CPC B29C 39/10; C08G 18/14; E04H 12/2292; B29C 39/123; B29C 39/44; B29C 31/008; B29C 31/02; C08G 18/32; C08G 18/7671; C08G 2101/00

(57) ABSTRACT

A container is provided that may include a transparent portion that reveals an interior portion of the container and an access aperture communicating with the interior portion of the container. A first component is placed into the interior portion. A second component is poured into the interior portion. The container is closed to fully enclose the first and second components. The first and second components in the container are agitated until the first and second components are a mixture of uniform continuum color, without an appearance of marbling and swirling, when viewed through the transparent portion of the container. The container is opened to expose the mixture of uniform continuum color. The mixture of uniform continuum color is poured from the container into a receiving structure. The mixture of uniform continuum color is transformed into a closed-cell polyurethane structure within the receiving structure.

### CROSS REFERENCE TO RELATED APPLICATIONS

This application is a continuation-in-part of copending U.S. patent application Ser. No. 13/649,861 filed Oct. 11, 2012, entitled “Closed-Cell Polyurethane Structure Method and System.”

### BACKGROUND

The ability to effectively fill pits or rock fissures, or secure poles or soil, etc. can be important for building a variety of structures. Historically, concrete has been used to fill pits or rock fissures, or secure poles or soil. Concrete is heavy and cumbersome to use, especially for smaller projects.

Accordingly, there is a continuing need for methods and systems that can fill and secure structures in a safe and efficient manner.

### SUMMARY

In accordance with various embodiments, a method generally features agitating a first component and a second component in a container until the first component and the second component are a mixture of a uniform continuum color, without an appearance of marbling and swirling, when viewed through a transparent portion of the container. The mixture of uniform continuum color may be poured from the container into a receiving structure. The mixture of uniform continuum color may be transformed into a closed-cell polyurethane structure within the receiving structure.

In accordance with various embodiments, a method generally features a container that may include a transparent portion that reveals an interior portion of the container, an access aperture communicating with the interior portion of the container, and a lid adjacent the access aperture. A first component may be placed through the access aperture into the interior portion of the container. A second component may be poured through the access aperture into the interior portion of the container. The lid of the container may be closed to fully enclose the first and second components. The first and second components in the container may be agitated until the first and second components are a mixture of uniform continuum color, without an appearance of marbling and swirling, when viewed through the transparent portion of the container. The lid of the container may be opened to expose the mixture of uniform continuum color. The mixture of uniform continuum color may be poured from the container into a receiving structure. The mixture of uniform continuum color may be transformed into a closed-cell polyurethane structure within the receiving structure.

These and various other features and advantages that characterize the claimed invention will be apparent upon reading the following detailed description and upon review of the associated drawings.

### BRIEF DESCRIPTION OF THE DRAWINGS

FIG. 1 shows a side view of an exemplary first container in accordance with various embodiments of the present disclosure.

FIG. 2 illustrates a side view of an exemplary second container in accordance with various embodiments of the present disclosure.

FIG. 3 provides a side view of the exemplary first container supporting the exemplary second container in accordance with various embodiments of the present disclosure.

FIG. 4 displays a side view of the exemplary first container with the lid closed to enclose the mixture in accordance with various embodiments of the present disclosure.

FIG. 5 shows a perspective view with partial cutaway view below a ground surface of an exemplary receiving structure and an exemplary target structure in accordance with various embodiments of the present disclosure.

FIG. 6 provides a flow chart representation of a polyurethane transformation operation in accordance with various embodiments of the present disclosure.

### DETAILED DESCRIPTION

Reference will now be made in detail to one or more examples of the disclosure depicted in the figures. Each example is provided by way of explanation of the disclosure, and not meant as a limitation of the present disclosure. For example, features illustrated or described as part of one embodiment may be used with another embodiment to yield still a different embodiment. Other modifications and variations to the described embodiments are also contemplated within the scope and spirit of the present disclosure.

FIG. 1 shows a first container 100. The first container 100 may include a transparent portion 102, an interior portion 104, an access aperture 106, a lid 108, and a handle 110. The transparent portion 102 reveals the interior portion 104 of the container. The access aperture 106 is communicating with the interior portion 104 of the container 100. The lid 108 is adjacent the access aperture 106. The lid 108 may be an integral feature of the first container 100 or may be communicated with the first container 100 via mating threads, snap fastener, or other suitable mechanism. The handle 110 may be sized to permit a finger of a user to wrap substantially all around the handle. An interior portion 112 of the handle 110 may be in fluidic communication with the interior portion 104. The handle 110 may make it easier for the user to move and pour out contents of the first container 100.

The first container 100 may contain a first component 114, and a headspace 116 in the interior portion 104 above the first component 114. The headspace 116 provides volume in the interior portion 104 of the first container 100 for the first component 114 to be agitated inside the container 100 when the lid 108 is closed.

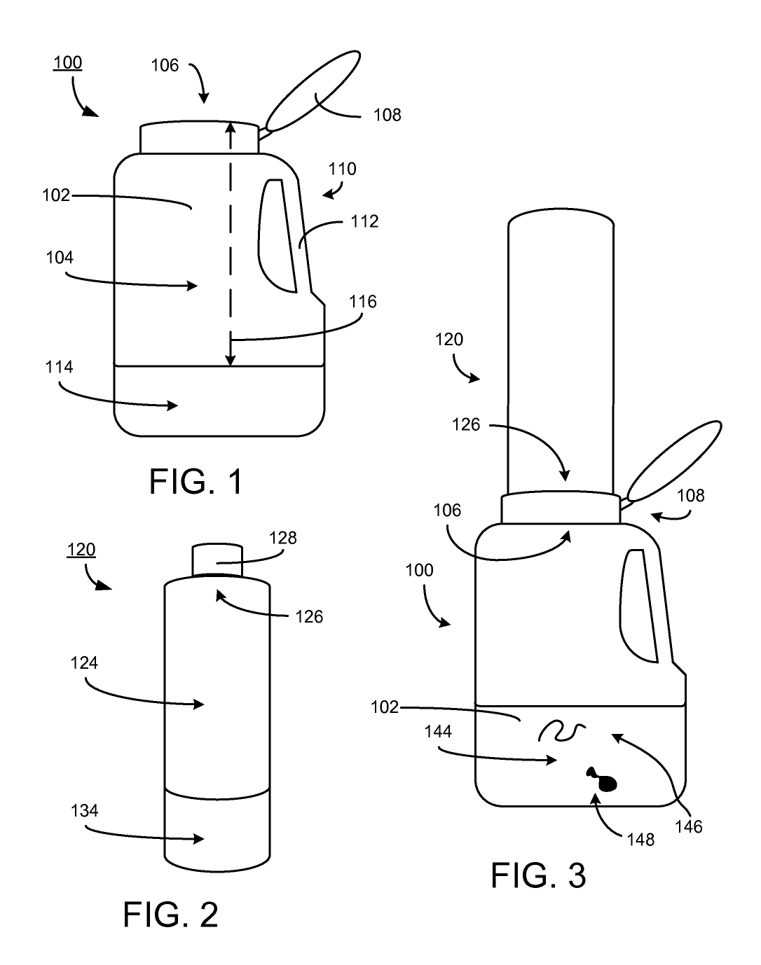

FIG. 2 illustrates a second container 120. The second container 120 may include an interior portion 124, an aperture 126, and a cap 128. The aperture 126 is communicating with the interior portion 124 of the container 100. The cap 128 is adjacent the aperture 126.

A second component 134 may be placed through the aperture 126 into the interior portion 124 of the second container 120.

The first component 114 and the second component 134 may combine to transform the first and second components 114, 134 into a polyurethane, such as a closed-cell polyurethane.

In an exemplary embodiment of the present disclosure, the first component 114 may belong to the chemical family of polyol system, such as a polyol available from E. I. du Pont de Nemours and Company, commonly referred to as DuPont (Global Headquarters: DuPont Building, 1007 Market Street, Wilmington, Del. 19898).

In an exemplary embodiment of the present disclosure, the second component 134 may belong to the chemical family of the Aromatic Isocyanate with chemical name Diphenylmethane Diisocyanate (MDI). The Aromatic Isocyanate or MDI is available from a variety of sources, such as Dow Chemical Company, commonly referred to as Dow (Corporate Headquarters: The Dow Chemical Company, 2030 Dow Center, Midland, Mich. 48674).

In various embodiments, the first component has a first density and the second component has a second density, and the first density is less than the second density. In addition, the first component has a first viscosity and the second component has a second viscosity, and the first viscosity is greater than the second viscosity.

FIG. 3 illustrates the first container 100 supporting the substantially full weight of the second container 120. The combination of the second container 120 and the first container 100 can be self-supporting such that the second container 120 can be disposed contactingly adjacent the first container 100 without the need for ongoing support from the user or another structure. In this position, substantially all of the second component may pour from the second container 120 into the first container 100 to form a mixture 144. The access aperture 106, the lid 108, and the aperture 126 may be configured and sized so the first container 100 may fully support the second container 120. The first and second components may or may not be hazardous materials, so minimizing the time that the user needs to hold the first and second containers may be beneficial. In addition, the hands of the user may be free to do other things while the second component pours into the first container 100.

As seen in FIG. 3, the mixture 144 may show non-uniform color with an appearance of marbling 146 and swirling 148. The transparent portion 102 has the property of transmitting light without appreciable scattering of the light, such that the mixture 144, the marbling 146, and the swirling 148 are seen clearly. Transparent is different than translucent. Translucent has the property of transmitting and diffusing light so that the mixture 144, the marbling 146, and the swirling 148 beyond could not be seen clearly.

In other words, the first container may support all the weight of the second container, which holds the second component, such that the aperture of the second container and the access aperture of the first container cooperate to form a conduit between the second container and the first container to pour substantially all of the second component into the first container.

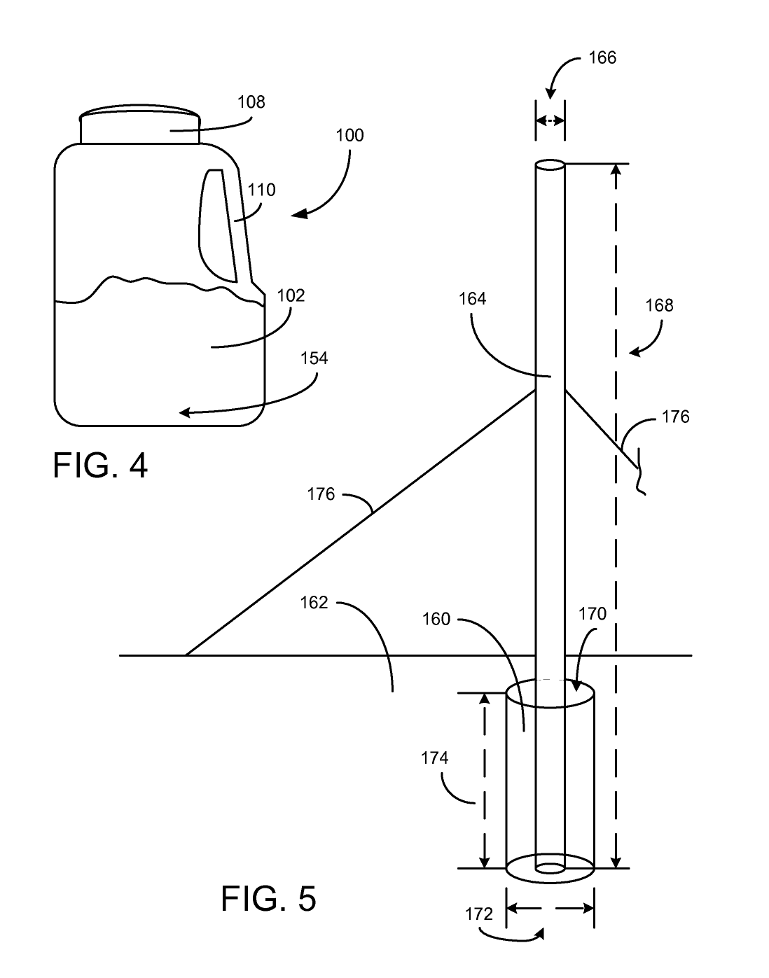

FIG. 4 demonstrates the lid 108 of the first container 100 may be closed with the mixture 154 fully enclosed by the first container 100 in the interior portion 104. The mixture 154 may continue a chemical reaction begun when the first component and the second component came into contact. The chemical reaction is exothermic. The volume occupied by the mixture 154 increases during the chemical reaction; therefore, the pressure increases in the first container 100 when the lid 108 is closed. The lid 108 serves as a pressure relief feature that opens when a pressure in the first container 100 is above a predetermined pressure.

The first and second components may be agitated by manually shaking the container. In other words, the user does not use a machine to agitate the first and second components. For instance, the user could hold the handle 110 of the first container 100 in the hand of the user. In addition, the first and second components may be agitated by mechanically shaking the container via a shaker machine, such as a paint shaker machine. The first and second components could be agitated by mechanically stirring the first and second components via a stirrer, with the lid 108 open or closed.

The first and second components, i.e., the mixture 154, in the first container 100 can be agitated until the first and second components are of uniform continuum color, without the appearance of marbling and swirling, when viewed through the transparent portion 102 of the first container 100. The transparent portion 102 enables the user to clearly see if and when the first and second components are of uniform continuum color, without the appearance of marbling and swirling. It is noted that the term uniform continuum color does not mean a single color. It means throughout the entirely of the material there is a consistency of color, without the requirement that the material be of a single color.

FIG. 5 reveals a receiving structure 160. The mixture of the first and second components can be poured into the receiving structure 160. The receiving structure 160 can be a pit in a ground surface 162, crack in a rock fissure, soil, or other suitable structure that can be secured with the mixture. The receiving structure 160 can encircle a target structure 164 that occupies a predetermined volume of the receiving structure. The target structure 164 could be a standard construction structure, such as a metal pole with an outer diameter 166 of 2 and ⅜ inches and a length 168 of 8 feet. Other suitable target structures include 4″ by 4″ wooden post, 1 and ⅝ inch post, such as typically used by DISH Network (Corporate Headquarters: 9601 S. Meridian Blvd., Englewood, Colo. 80112) for mounting a satellite dish, etc.

The mixture of uniform continuum color can transform into a closed-cell polyurethane structure 170 within the receiving structure 160.

The receiving structure 160 can take various forms and sizes. In FIG. 5, the receiving structure 160 has an inner diameter 172 of 6″ and a depth 174 of 24″ when the target structure 164 is the 2 and ⅜ inch metal pole, and the receiving structure 160 has an inner diameter 172 of 8″ and a depth 174 of 24″ when the target structure 164 is 4″ by 4″ wooden post. In either situation, the total volume of the first and second components can be about 28 fluid ounces. When the total volume of the first and second components is about 28 fluid ounces, the volume of the first component can be about 14 fluid ounces and the volume of the second component can be about 14 fluid ounces.

In a most preferred embodiment, the first component (polyol) is provided in a volume of 14.75 oz. (531 grams), while the second component (isocyanate) is provided in a volume of 17.25 oz. (677 grams), which provides a volumetric ratio (A:B) substantially equal to 1:17, and mass ratio (A:B) substantially equal to 1:1.275, in a total volume of 32 oz. The most preferred embodiment assures the polyol is fully reacted, and the excess isocyanate is diffused through the expanded polyurethane at the wall structure of the micro cells of the expanded polyurethane. This most preferred embodiment improves the stiffness and compressive strength of the expanded polyurethane, which provides improved utility for its intended application.

For combinations of the receiving structure 160 and the target structure 164 of these sizes, a range of the total volume of the first and second components can be in a range from about 14 fluid ounces to about 50 fluid ounces. The lower end of the range, e.g., about 14 fluid ounces, may be result in the closed-cell polyurethane structure 170 that is too soft for practical use in supporting the target structure 164 in the receiving structure 160. However, it is contemplated that continued improvements in closed-cell polyurethane structure materials may lead to smaller total fluid volumes yielding the closed-cell polyurethane structure 170 that can support the target structure 164.

The higher end of the end, e.g., about 50 fluid ounces, should result in the closed-cell polyurethane structure 170 that is very strong and effective in supporting the target structure 164, but the high volume of the first and second components may not be viable from an economic standpoint. That is the high end of the total volume of about 50 fluid ounces may cost too much to handle, ship, use, etc. in the marketplace. However, it is contemplated that closed-cell polyurethane structure materials may become cheaper in the future, such that cost is not a limiting factor in choosing the total volume of the first and second components. In addition, about 50 fluid ounces or more may be too heavy for the user to agitate the first and second components.

### In a Most Preferred Embodiment

When the target structure 164 is the 1 and ⅝ inch post, the inner diameter 172 is 6″ and a depth 174 of 18″. In this situation, the total volume of the first and second components may be about 16 fluid ounces. The total volume of the first and second components can be about 16 fluid ounces, with the volume of the first component about 8 fluid ounces and the volume of the second component about 8 fluid ounces. As above, other volumes of the first and second components are possible, and the first and second components may not be of the same volume as each other. For combinations of the receiving structure 160 and the target structure 164 of these sizes, a range of the total volume of the first and second components can be in a range from about 8 fluid ounces to about 28 fluid ounces.

Other volumes of the first and second components are possible. The first and second components may not be of the same volume as each other. In other words, the volume of the first component and the volume of the second component may be volumes other than a one to one (1:1) ratio between the first and second components.

All dimensions provided in the disclosure are approximate, and it is understood that by conventional dimensions may be exemplary, such as the 4″ by 4″ wooden post may actually be 3.5″ by 3.5″.

A stabilization structure 176 may be provided. The target structure 164 may be positioned in the receiving structure 160 in a desired position. The target structure 164 is stabilized in the receiving structure 160 via cooperation of the stabilization structure 176 with the target structure 164. The stabilization structure 176 engages the target structure 164 and the ground surface 162. There may be a plurality of stabilization structures 176. However, the stabilization structure 176 is optional. For example, the target structure 164 in the receiving structure 160 may be stabilized by the hand of the user in a selected orientation of the target structure 164 in relation to the receiving structure 160.

The target structure 164 may be stabilized in the receiving structure 160 by the user holding the target structure 164 in the desired position.

When the mixture of uniform continuum color has transformed into the closed-cell polyurethane structure 170, the closed-cell polyurethane structure 170 will act to stabilize the target structure 164 in the desired position without ongoing stabilization of the target structure 164 in the receiving structure 160 by the stabilization structure 176, the user, or other suitable manner of stabilization.

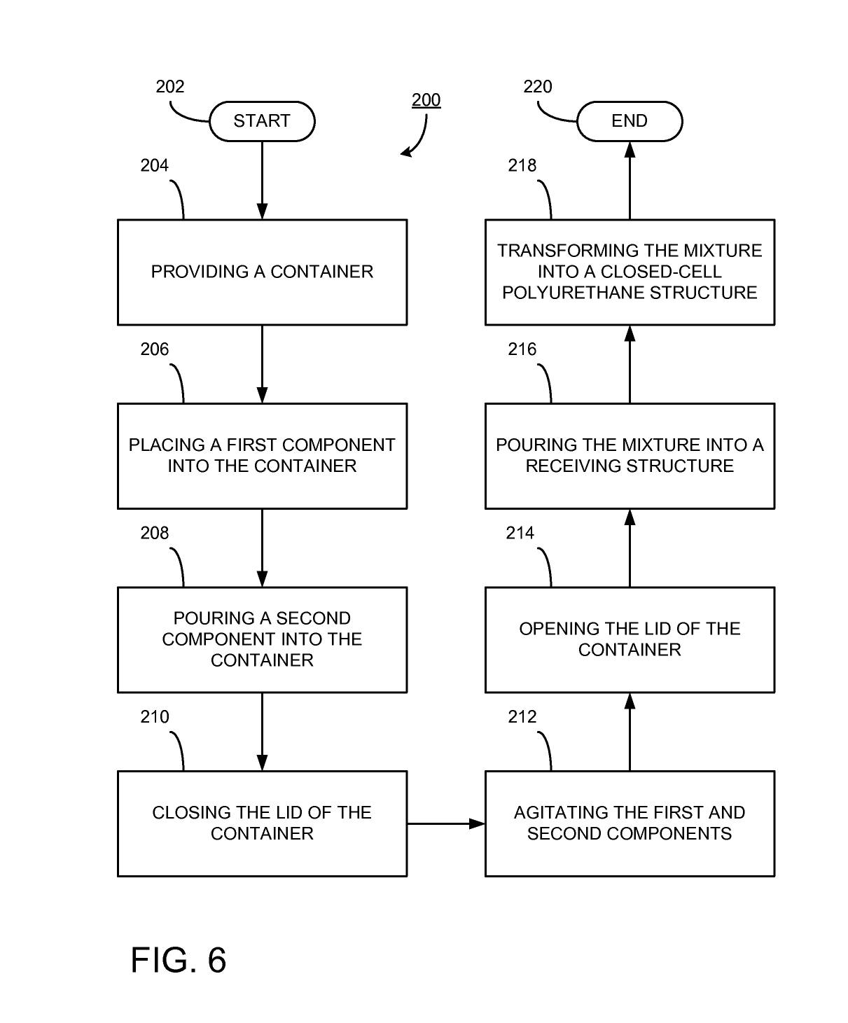

FIG. 6 provides a flow chart for a CLOSED-CELL POLYURETHANE TRANSFORMATION routine 200 illustrative of various steps that may be carried out in accordance with the present disclosure starts at step 202.

At process step 204, a container is provided. The container may include a transparent portion that reveals an interior portion of the container, an access aperture communicating with the interior portion of the container, and a lid adjacent the access aperture.

At process step 206, a first component is placed through the access aperture into the interior portion of the container.

At process step 208, a second component is poured through the access aperture into the interior portion of the container.

At process step 210, the lid of the container is closed to fully enclose the first and second components.

At process step 212, the first and second components in the container are agitated until the first and second components are a mixture of uniform continuum color, without an appearance of marbling and swirling, when viewed through the transparent portion of the container.

At process step 214, the lid of the container is opened to expose the mixture of uniform continuum color.

At process step 216, the mixture of uniform continuum color is poured from the container into a receiving structure.

At process step 218, the mixture of uniform continuum color is transformed into a closed-cell polyurethane structure within the receiving structure.

At process step 220, the routine 200 ends.

It should be noted that the various steps are not limited to singular function. That is, several of the steps, such as steps 206 and 208 can be carried out simultaneously. Likewise, the position of the elements of the closed-cell polyurethane transformation can vary without deterring from the spirit of the present disclosure. Regardless, various steps of the operation 200 of FIG. 6 can be omitted, substituted, or repeated as necessary without diverting from the spirit of the present disclosure.

While the present disclosure has been described in connection with an exemplary embodiment, it is not intended to limit the scope of the present disclosure to the particular form set forth, but on the contrary, it is intended to cover such alternatives, modifications, and equivalents as may be included within the spirit and scope of the present disclosure as defined by the appended claims.

It will be clear that the present disclosure is well adapted to attain the ends and advantages mentioned as well as those inherent therein. While exemplary embodiments have been described for purposes of this disclosure, numerous changes may be made which will readily suggest themselves to those skilled in the art and which are encompassed by the appended claims.

What is claimed is:

1. A method by steps comprising:
providing a container, said container including at least a transparent portion that reveals an interior portion of the container and an access aperture communicating with the interior portion of the container;
placing a first component through the access aperture into the interior portion of the container;
pouring a second component through the access aperture into the interior portion of the container, wherein component one is provided in a volumetric ratio, relative to component two, substantially equal to one (1) to one (1) point (.) seven, that is (1:1.7);
closing the container to fully enclose the first and second components;
agitating the first and second components in the container until the first and second components are a mixture of uniform continuum color, without an appearance of marbling and swirling, when viewed through the transparent portion of the container;
opening the container to expose the mixture of uniform continuum color;
pouring the mixture of uniform continuum color from the container into a receiving structure; and
transforming the mixture of uniform continuum color into a closed-cell polyurethane structure within the receiving structure.

2. The method of claim 1, in which the receiving structure encircles a target structure, said target structure occupies a predetermined volume of the receiving structure.

3. The method of claim 1, in which the first component comprises a polyol.

4. The method of claim 1, in which the second component comprises an aromatic isocyanate.

5. The method of claim 1, in which the second component comprises a diphenylmethane diisocyanate.

6. The method of claim 1, in which the first component has a first density and the second component has a second density, and the first density is less than the second density.

7. The method of claim 1, in which the first component has a first viscosity and the second component has a second viscosity, and the first viscosity is greater than the second viscosity.

8. The method of claim 1, in which the agitating step comprises agitating the first and second components by manually shaking the container.

9. The method of claim 1, in which the agitating step comprises agitating the first and second components by mechanically shaking the container via a shaker machine.

10. The method of claim 1, in which the agitating step comprises agitating the first and second components by mechanically stirring the first and second components via a stirrer.

11. The method of claim 1, in which the total volume of the first component and the second component is about 32 fluid ounces.

12. The method of claim 1, in which the total volume of the first component and the second component is in a range of about 14 fluid ounces to about 50 fluid ounces.

13. The method of claim 1, by steps further comprising:
providing a stabilization structure;
positioning a target structure in the receiving structure;
stabilizing the target structure in the receiving structure via cooperation of the stabilization structure with the target structure.

14. The method of claim 14, in which the stabilization structure is one of a plurality of stabilization structures that stabilize the target structure in the receiving structure.

15. A method by steps comprising:
agitating a first component and a second component in a container until the first component and the second component are a mixture of uniform continuum color, without an appearance of marbling and swirling, when viewed through a transparent portion of the container;
pouring the mixture of uniform continuum color from the container into a receiving structure; and
transforming the mixture of uniform continuum color into a closed-cell polyurethane structure within the receiving structure.

16. A system comprising:
a container including at least a transparent portion that reveals an interior portion of the container, an access aperture communicating with the interior portion of the container, and a lid adjacent the access aperture;
a first component in the interior portion of the container;
a second component in the interior portion of the container, the first and second components in the container form a mixture of uniform continuum color, without an appearance of marbling and swirling, when viewed through the transparent portion of the container; and
a closed-cell polyurethane structure within a receiving structure transformed from the mixture of uniform continuum color.
